(19) United States
(12) Patent Application Publication
(10) Pub. No.: US 2025/0267774 A1
(43) Pub. Date: Aug. 21, 2025

(54) METHOD FOR ANALYZING SOUNDS IN A VEHICLE AND ACTIVATING A DISCO MODE IN THE VEHICLE BASED ON THE SOUNDS

(71) Applicant: Dr. Ing. h.c. F. Porsche Aktiengesellschaft, Stuttgart (DE)

(72) Inventor: Ethan Papp, Union City, CA (US)

(73) Assignee: Dr. Ing. h.c. F. Porsche Aktiengesellschaft, Stuttgart (DE)

(21) Appl. No.: 18/444,866

(22) Filed: Feb. 19, 2024

(51) Int. Cl. H05B 47/105; B60Q 3/70; G10H 1/00

(52) U.S. Cl. CPC H05B 47/105; B60Q 3/70; G10H 1/0008; G10H 2210/076

(57) ABSTRACT

A computer-implemented method and computer program product for analyzing sounds within a vehicle interior and controlling ambient light system within the vehicle interior. The method includes the steps of: (a) connecting a software application to a vehicle network; (b) capturing, by the software application, at least one sound within the vehicle interior; (c) analyzing, by the software application, the at least one sound captured within the vehicle interior; and (d) changing an appearance of at least one portion of the ambient light system within the vehicle interior based on the captured at least one sound within the vehicle interior. The computer program is configured to perform the aforementioned steps.

### TECHNICAL FIELD

The present subject matter relates to a system and method for analyzing sounds within a vehicle interior and controlling the ambient lights within the vehicle interior in synchronization with the sounds.

### BACKGROUND

The modern automobile in recent years has seen a massive expansion in the number of internal electronic control systems. The use of mobile and wearable electronic devices also continues to increase. Most automobiles are capable of communicating with a smartphone carried by, or a smartwatch worn by, a driver or a passenger in the vehicle. For example, a smartphone is configured to communicate with an Apple CarPlay software system within the vehicle. With the rapid development of mobile technologies, users have higher demands for the convenience of use of in-vehicle software applications (e.g., “apps”). Currently, users can either use an original in-vehicle application provided by the vehicle manufacturer or connect a smartphone to the vehicle onboard computer, and then project an app installed on the smartphone onto the vehicle display screen through Apple CarPlay, Android Auto, CarLife, or other software connectivity protocols. Most users use the vehicle infotainment system or different apps for playing music, particularly during a long drive.

As is described in U.S. patent application Ser. No. 18/219,933, which is incorporated by reference herein in its entirety, in-vehicle functions (e.g., audio, lighting, video, displays, climate control, etc.) may be integrated within the CarPlay app to create an innovate, personalized experience for the vehicle driver and passengers. Accordingly, the driver and passengers can control various in-vehicle functions via a connected smartphone because the smartphone is connected to the in-vehicle CarPlay app, the CarPlay app is integrated within the vehicle infotainment system, and the vehicle infotainment system is interconnected with the in-vehicle network of controllers, sensors and computers.

Advancements in the area of internal electronic control systems are continually sought in the interests of user enjoyment, convenience, performance, and safety. Described herein is an electronic control system which controls the ambient lighting system within the vehicle interior based on the kind of music played within the vehicle, thereby reflecting the user's mood and enhancing the in-vehicle user experience, without much effort or distraction from driving.

### SUMMARY OF INVENTION

Described herein are a method and a computer program product for analyzing sounds within a vehicle interior and controlling ambient light system within the vehicle interior, thereby enhancing the in-vehicle experience. The method includes the steps of: (a) connecting a software application to a vehicle network; (b) capturing, by the software application, at least one sound within the vehicle interior; (c) analyzing, by the software application, the at least one sound captured within the vehicle interior; and (d) changing an appearance of at least one portion of the ambient light system within the vehicle interior based on the captured at least one sound within the vehicle interior and (optionally) based on preferences of the user. The computer program product is configured to perform the aforementioned steps.

### BRIEF DESCRIPTION OF THE DRAWINGS

The drawing figures depict one or more implementations, by way of example only, not by way of limitations. In the figures, like reference numerals refer to the same or similar elements.

FIG. 1 depicts a schematic diagram of a vehicle and a mobile device connected to the vehicle.

FIG. 2 depicts a schematic diagram of a system including a vehicle and a mobile device for analyzing sounds within a vehicle interior and controlling ambient light system within the vehicle interior.

FIG. 3 is a schematic diagram of a computer program according to an embodiment.

FIG. 4 is a flowchart depicting an overall method for analyzing sounds within a vehicle interior and controlling ambient light system within the vehicle interior.

### DETAILED DESCRIPTION

In the following detailed description, numerous specific details are set forth by way of examples in order to provide a thorough understanding of the relevant teachings. However, it should be apparent to those skilled in the art that the present teachings may be practiced without such details. In other instances, well known methods, procedures, components, and/or circuitry have been described at a relatively high-level, without detail, in order to avoid unnecessarily obscuring aspects of the present teachings.

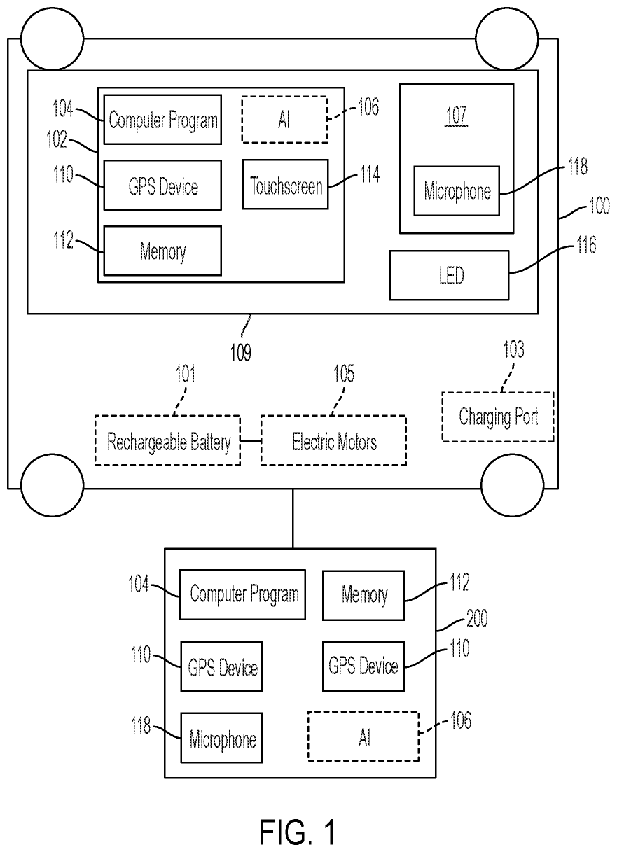

FIG. 1 depicts an exemplary vehicle 100. The vehicle 100 can be an electric vehicle having a rechargeable battery 101, a charging port 103 used for charging the battery 101, and one or more electric motors 105, for example. Regardless of the type of vehicle 100, vehicle 100 has a computer 102 for controlling functions related to the operations of vehicle 100 and an infotainment system 107 including audio speakers, a smartphone mirroring system app (e.g., CarPlay), an optional microphone 118, navigation, telematics, internet access, etc. Infotainment system 107 may be considered as forming part of computer 102. An electronic mobile device 200 (otherwise referred to herein as a smartphone) is connected to vehicle computer 102 via a wired or wireless connection (e.g., Wi-Fi, cellular or Bluetooth connection). It is noted that components that are shown in broken lines in FIG. 1 are optional.

Vehicle computer 102 includes a processor, a visual display 114 having means for both inputting data and displaying data (e.g., touchscreen), a transmitter/receiver for communicating with mobile device 200 in a conventional manner, and a GPS device 110. For example, vehicle computer 102 may send and receive data via Wi-Fi or 4G/LTE radios built into vehicle 100, by way of example. Mobile device 200 includes a processor, a visual display having means for both inputting data and displaying data (e.g., touchscreen), a transmitter/receiver for communicating with vehicle 100 in a conventional manner, and a microphone 118.

At least one interior light 116, such as a light emitting diode (“LED”), for example, can be arranged in different areas within the interior 109 of the vehicle 100. For example, the LED 116 can be arranged and configured to provide illumination around the dashboard, the center console, the door handles, the cupholders, the door panels, the door and dash trim, the climate control vents, the speaker surrounds, and/or the footwells of the vehicle 100. Although only one LED 116 is illustrated in FIG. 1, several LEDs 116 can be arranged in arrays in different areas within the interior 109 of the vehicle 100.

A computer program 104 or a software application (e.g., “app”) is downloaded to, installed on, and stored in, either electronic mobile device 200 or computer 102 of vehicle 100 (or both). According to one embodiment, program 104 is stored within the mobile device 200; information can be inputted into program 104 via the display 114 of mobile device 200; and information can be outputted from program 104 via the display of vehicle computer 102 (e.g., via Apple CarPlay or Android Auto). According to another embodiment, program 104 is stored within the vehicle computer 102; information can be inputted into program 104 via the touchscreen display 114 of vehicle computer 102; and information can be outputted from program 104 via the display of vehicle computer 102 (e.g., via Apple CarPlay or Android Auto).

According to yet another embodiment, program 104 is a mobile application stored within the mobile device 200; information can be inputted into program 104 via the display of mobile device 200; and information can be outputted from program 104 via the display of mobile device 200. According to still another embodiment, program 104 is stored within the mobile device 200; information can be inputted into program 104 via the display of mobile device 200; and information can be outputted from program 104 via both the display of mobile device 200 and the display of vehicle computer 102.

Program 104 can be displayed on the touchscreen display 114 of vehicle computer 102. The functionality of program 104 can be enabled or disabled by user input on the touchscreen display 114 of vehicle computer 102.

In certain embodiments, users of the vehicle 100 may be identified by program 104 based on paired device data maintained in the memory 112 of program 104. The paired device data can indicate, for example, unique device identifiers of mobile devices that were previously paired with program 104 of the vehicle 100, such that program 104 may automatically reconnect previously connected mobile devices without user intervention.

In certain embodiments, program 104 can be configured to interact with an AI chatbot model, such as ChatGPT, for example, which can run as a third-party software application (e.g., “app”) AI 106 on vehicle computer 102 or on the mobile device 200 of the user of the vehicle 100. In other embodiments, the AI model can be a different AI-enabled software application 106 running on vehicle computer 102 or on the mobile device 200 of the user of the vehicle 100. Program 104 can be configured to interact with the AI model or ChatGPT app 106 and use ChatGPT's API to perform an action (e.g., query) specified by the user. Further details of the AI model are described in U.S. patent application Ser. No. 18/201,799 filed on May 25, 2023, which is incorporated by reference herein in its entirety and for all purposes.

Program 104 can be designed and configured to connect directly to the network of the vehicle 100 and/or a third-party software applications (e.g., other “apps”) or devices via a direct connection application programming interface (API). For example, program 104 can be configured to interact with other apps installed on vehicle computer 102, such as different apps for social media, messaging, providing maps and navigation, playing music or podcasts, etc., that may be installed on, and be available via the display of, vehicle computer 102 (e.g., via Apple CarPlay or Android Auto), for example, or with other similar apps installed on mobile device 200. In these situations, because these apps are integrated with program 104, program 104 can use each specific app's API to perform an action specified by the user.

In certain embodiments, program 104 can appear as a selectable icon within Apple CarPlay. Program 104 can be configured to connect the network of the vehicle 100 with the Apple ecosystem (e.g., with the different Apple devices, such as iPhone, iPad, MacBook, Apple Watch, AirPods, Apple TV, Apple CarPlay, etc.) that may be connected and integrated with each other, and that may be accessible within the vehicle 100. Once connected to the Apple ecosystem, program 104 can run in the background of Apple CarPlay, for example.

The network of the vehicle 100 can include one or more of a vehicle controller area network (“CAN”) or an Ethernet network, for example. The network of the vehicle 100 can allow, after proper and successful authentication, program 104 to communicate with various systems or components of vehicle 100, such as a vehicle modem (if available), GPS device 110 and various electronic control units (“ECUs”) configured to interface with program 104. For example, the vehicle ECUs may include a vehicle interior control module configured to monitor and control power control functions, such as interior lighting or infotainment system 107, for example; a radio transceiver module configured to provide radio services and communicate with mobile devices inside vehicle 100; etc.

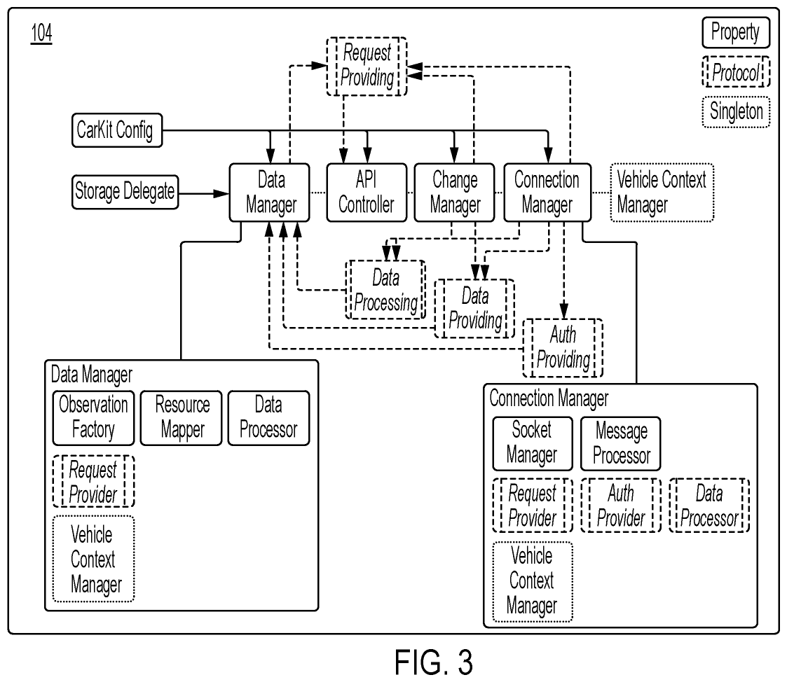

Program 104 can be configured to include different components to facilitate access to one or more features of vehicle 100 that may be provided with a default configuration by the manufactures of vehicle 100 and may be configured for changes or customization by the user of vehicle 100. For example, program 104 can include a Data Manager, a Connection Manager, an API Controller, and a Change Manager, as illustrated in FIG. 3, for example. The Data Manager can be configured, for example, to provide, process, and update an RSI Request-Response Interface authorization and RSI resource mapping. The Connection Manager can be configured, for example, to check network conditions through a network controller, re-check connection when network conditions change, search for an infotainment web interface protocol, such as the Volkswagen Infotainment Web Interface (“VIWI”) RSI service, for example, handle authentication, collect initial information (e.g., vehicle data) about different components of the vehicle 100, and process updates to vehicle data requested by the user of vehicle 100.

Program 104 can be configured to access a list of available features of the vehicle 100, including but not limited to initial or default values of the available features of the vehicle 100, before allowing the user of vehicle 100 access to modify or customize the available features of the vehicle 100. Once program 104 has gathered and parsed the initial vehicle data, program 104 can monitor for any changes to the initial vehicle data. For example, program 104 can open a WebSocket API as a two-way interactive communication session between the user's interface of program 104 and a server connected to a two-way interactive communication session between the user's browser and a server to observe, process, and store any and all changes by the user to the initial vehicle data. After the user's modifications to any of the available features of the vehicle 100 are processed and stored in the memory 112 of program 104, program 104 can be configured to synchronize the modified features of the vehicle 100 with the corresponding system or component of the vehicle 100.

In addition, program 104 can be configured to auto detect any smart devices (e.g., smart phones, smart watches, tablets, etc.) that are compatible with program 104, and that may be accessible within the vehicle 100, and auto connect with these devices as soon as they are setup, without the necessity for the user to set up these devices each time. As another example, program 104 can connect to a smart device via a direct connection application programming interface (API).

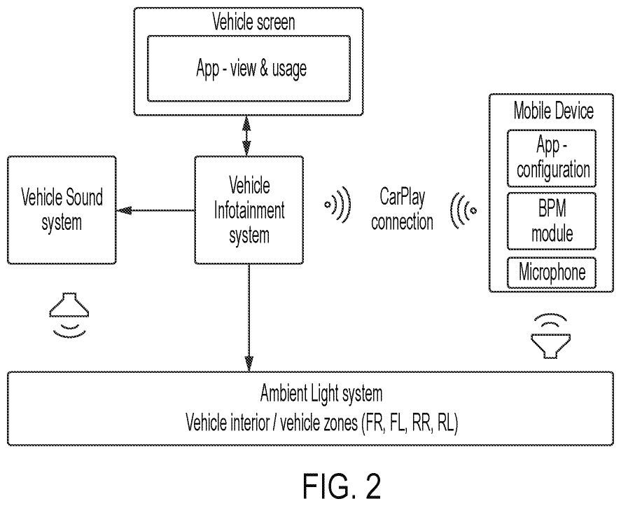

Program 104 can be configured to capture sound within the vehicle interior 109 using microphone 118 of the mobile device 200 or the vehicle, for example. The sound within the vehicle interior can be music played by the vehicle infotainment system 107 or by different apps for streaming and playing music. The different music apps can run on the mobile device 200 or on the vehicle infotainment system 107. The sounds captured by microphone 118 are transmitted to the processor of the mobile device 200, which analyzes the characteristics of the captured sounds. The characteristics of the captured sounds may include, for example, parameters related to the tempo of the music, such as beats per minute (“BPM”), for example. The program 104 can include a BPM module (FIG. 2) that can be configured to apply a trained sound model to the captured sounds. The trained sound model can be part of the AI model 106 or part of a different trained sound model programmed in the software application 104 running on the mobile device 200. For example, the BPM module can be configured to apply a Fourier transform analysis to the captured sounds to determine distinguishing parameters of the sound (e.g., beats, frequency of beats, tempo, etc.), for example. Further details of a trained sound model that applies a Fourier transform analysis to the captured sounds are described in U.S. Patent Application Publication No. 2009/0287323, which is incorporated by reference herein in its entirety and for all purposes.

Program 104 can be configured to access, via the mobile device 200 (for example), a list of different user-configurable appearances of the ambient light system within the vehicle interior. For example, the program 104 can associate each of the user-configurable appearances of the ambient light system with a specific kind of music (e.g., disco, dance, pop, rap, rock, classical, etc.). In particular, each of the user-configurable appearances of the ambient light system can be associated with, or correspond to, at least one characteristic, such as beats per minute (“BPM”), for example, of the music played within the vehicle interior 109.

Program 104 is configured to change the appearance of at least one portion of the ambient light system within the vehicle interior (e.g., the illumination around a dashboard, a center console, door handles, cupholders, door panels, and footwells of the vehicle) based on the captured at least one sound within the vehicle interior 109.

Saved in the memory 112 of the program 104 are a plurality of different appearances of the ambient light system, each of which corresponding to a different audio characteristic, such as beats per minute (“BPM”), for example, of the music played within the vehicle interior 109 and sensed by the microphone 118. The different appearances of the ambient light system within the vehicle interior can include, but are not limited to, at least one of color, brightness, color sequence, or flash sequence, of the LED(s) 116 in at least one of a plurality of zones (e.g., front right zone, front left zone, rear right zone, and a rear left zone) within the vehicle interior 109. For example, high tempo music or even the sound of an emergency vehicle near the vehicle could correspond to flashing red interior lights. The flash sequence of the light may also correspond to particular beats in the audio, e.g., a light flash for every beat having a particular wavelength. The computer program 104 runs at a sufficient speed such that any time lag between a beat and a light flash would be imperceptible to the passenger.

Alternatively, using the user interface of the program 104, the user can configure and customize multiple user-configurable appearances of the ambient light system to his or her unique preferences. For example, in certain embodiments, the user can configure, on the mobile device 200 (for example), that the same user-configurable appearance of the ambient light system applies to all portions of the ambient light system within the vehicle interior (e.g., the illumination around a dashboard, a center console, door handles, cupholders, door panels, and footwells of the vehicle). In other embodiments, the user can configure, on the mobile device 200, that a certain user-configurable appearance of the ambient light system applies only to certain (but not to all) portions of the ambient light system within the vehicle interior. For example, the user can configure, on the mobile device 200, that a certain user-configurable appearance of the ambient light system applies only to the illumination around the dashboard, the center console, and the driver's footwell of the vehicle.

After the user's modifications to any of the available user-configurable appearances of the ambient light system are processed and stored in the memory 112 of program 104, program 104 can be configured to synchronize the modified user-configurable appearances of the ambient light system with the corresponding portion of the ambient light system (e.g., the illumination around a dashboard, a center console, door handles, cupholders, door panels, and footwells of the vehicle) controlled by the mobile device 200.

The list of multiple different user-configurable appearances of the ambient light system within the vehicle interior can include, but is not limited to, initial or default appearances of the ambient light system, before allowing the user of mobile device 200 access to modify or customize the available user-configurable appearances of the ambient light system. Once program 104 has gathered and parsed the initial appearances of the ambient light system, program 104 can monitor for any changes to the initial appearances of the ambient light system. For example, program 104 can open a WebSocket API as a two-way interactive communication session between the user's interface of program 104 and a server connected to a two-way interactive communication session between the user's browser and a server to observe, process, and store any and all changes by the user to the initial appearances of the ambient light system. After the user's modifications to any of the available user-configurable appearances of the ambient light system are processed and stored in the memory 112 of program 104, program 104 can be configured to synchronize the modified user-configurable appearances of the ambient light system with the corresponding portion of the ambient light system (e.g., the illumination around a dashboard, a center console, door handles, cupholders, door panels, and footwells of the vehicle) controlled by the mobile device 200.

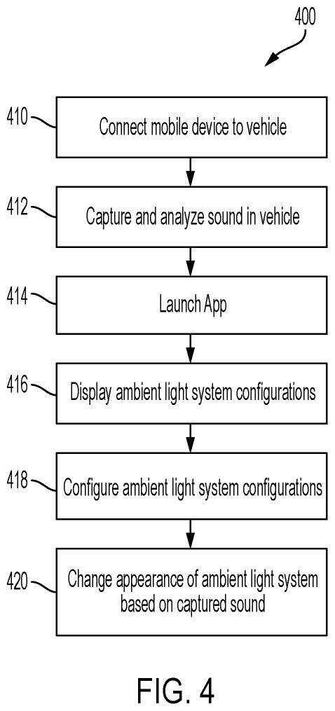

FIG. 4 is a flowchart depicting an overall method 400 for analyzing sounds within a vehicle interior and controlling ambient light system within the interior of the vehicle 100. The user of the vehicle 100 can be a driver of the vehicle 100 or a passenger in the vehicle 100. It is also noted that method 400 uses mobile device 200 along with vehicle 100 to accomplish method 400, however, it should be understood that vehicle computer 102 of vehicle 100 may be omitted and the steps of method 400 may be completed using only mobile device 200. Alternatively, mobile device 200 may be omitted and the steps of method 400 may be completed using only vehicle computer 102 of vehicle 100.

At step 410 of method 400, mobile device 200 connects to vehicle 100 in either a wired or wireless manner, as described above. If the steps of method 400 are completed by vehicle 100 itself (and without the assistance of mobile device 200), then this step may be omitted.

Optionally, after the connection between the mobile device 200 and the vehicle 100 is established, program 104 can initiate an authentication of the mobile device 200 and/or the vehicle 100. The authentication can be performed using known methods, such as Transport Layer Security (“TLS”) 1.2 security protocol, public pinning hash, local certificate pinning, PIN numbers that can be entered by the user or QR codes that can be scanned by the mobile device 200, for example. Further functionality of program 104 can be disabled until after the mobile device 200 and/or the vehicle 100 successfully complete the authentication process (e.g., the mobile device 200 confirms that the saved user and vehicle information is stored in the vehicle 100).

At step 412 of method 400, the microphone 118 of mobile device 200 captures sound within the vehicle interior 109, as described above. The sound within the vehicle interior 109 can be music played by the vehicle infotainment system (e.g., infotainment system 107) or by different music apps running on the mobile device 200 or on the vehicle computer 112 or local sounds (e.g., sirens) that are not being played via infotainment system 107. The sounds captured by microphone 118 are transmitted to the program 104 installed on the mobile device 200, which analyzes the characteristics of the captured sounds. The characteristics of the captured sounds may include, for example, parameters related to the tempo of the music, such as beats per minute (“BPM”), for example. The program 104 can apply a trained sound model using a Fourier transform analysis to the captured sounds to determine distinguishing parameters of the sound (e.g., beats, tempo, etc.), for example, as explained above.

At step 414, the user (e.g., driver or passenger of vehicle 100) launches program 104 on mobile device 200 or on vehicle computer 102. Step 414 may occur automatically at step 410, or either prior to a vehicle trip or during the vehicle trip.

At optional step 416, if the user desires to select an appearance for a unique experience, program 104 displays a plurality of different user-configurable appearances of the ambient light system within the vehicle interior. For example, each of the user-configurable appearances of the ambient light system can include, but is not limited to, at least one of color, brightness, color sequence, or flash sequence, of the LED(s) 116 in at least one of a plurality of zones (e.g., front right zone, front left zone, rear right zone, and a rear left zone) within the vehicle 100.

Before displaying to the user, in step 416, the internal listing of user-configurable appearances of the ambient light system within the vehicle interior, the listing may be sorted, arranged and organized in a certain fashion. As one example for sorting the listing, program 104 checks for the most recently used or the most often used appearances of the ambient light system and automatically organizes the appearances of the ambient light system such that the most recently used or the most often used appearances of the ambient light system appear at the top of the list.

As another example, program 104 can recognize the user of the vehicle 100 (e.g., in case multiple users use the same vehicle 100) and can automatically display the ambient light system configurations that were most recently used or are most often used by the recognized user.

At optional step 418, program 104 receives from the user (e.g., driver or passenger) of the vehicle 100 user input associating, in program 104, each of the user-configurable appearances of the ambient light system with a specific captured sound or kind of music (e.g., disco, dance, pop, rap, rock, classical, etc.). In particular, each of the user-configurable appearances of the ambient light system can be associated with, or correspond to, at least one characteristic, such as beats per minute (“BPM”), for example, of the music played within the vehicle interior. The user input can be in the form of the user selecting an icon or pressing a button on the touchscreen 114 of the user interface of program 104. Alternatively, the user input can be in the form of a voice command by the user over an audio system of the mobile device 200. In certain embodiments, for example, Apple Siri can be expanded to enable user input, selection, and modification of vehicle functions and external functions through the program 104.

The user-configurable appearances of the ambient light system associated with a specific kind of music may be saved in the memory 112 of the mobile device 200, for example.

The user's selection can be saved in the memory 112 of the mobile device 200 for either current use or later use. The user's selection saved in memory 112 is made available for use by program 104. Once saved, the saved appearances of the ambient light system associated with a specific kind of music may be presented to the user as selectable icons (e.g., icons named “Disco,” “Dance,” “Pop,” “Rap,” “Rock,” etc.), for example, on the display of mobile device 200. Each icon may be in the form of a single softkey button on the display and within the user interface of program 104, for example.

The optional step 418 of configuring the plurality of user-configurable appearances of the ambient light system based on the user's preferences can be executed by program 104 running on the smartphone 200 or on the vehicle computer 100, in real time between the smartphone 200 and the infotainment system of the vehicle 100.

Turning back to FIG. 4, at step 420, without any user intervention, program 104 changes the appearance of at least one portion of the ambient light system within the vehicle interior based on the captured sound within the vehicle interior and (optionally) based on the preferences of the user (e.g., using the user-configurable appearances of the ambient light system).

It should be understood that method 400 is not limited to any particular step or sequence of steps.

In the context of the present description, the functions of program 104 may be carried out by a processor. The processor can be understood to mean a machine or an electronic circuit, for example. In particular, a processor can be a central processing unit (CPU), a microprocessor or microcontroller, for example an application-specific integrated circuit or digital signal processor, possibly in combination with a data storage unit for storing program commands, etc. Additionally, a processor can be understood to be a virtual processor, a virtual machine or soft CPU. The program 104 may be stored in the memory of the machine.

It will be understood that the operational steps are performed by the computers or processors described herein upon loading and executing software code or instructions which are tangibly stored on a tangible, non-transitory computer readable storage medium, such as on a magnetic medium, e.g., a computer hard drive, an optical medium, e.g., an optical disc, solid-state memory, e.g., flash memory, or other storage media known in the art. Thus, any of the functionality performed by the computers or processors described herein described herein is implemented in software code or instructions which are tangibly stored on a tangible, non-transitory computer readable storage medium. Upon loading and executing such software code or instructions by the computers or processors, the computers or processors may perform any of the functionality of the computers or processors described herein, including any steps of the methods described herein.

The term “software code” or “code” used herein refers to any instructions or set of instructions that influence the operation of computers or processors. They may exist in a computer-executable form, such as machine code, which is the set of instructions and data directly executed by a computer's central processing unit or by a controller, a human-understandable form, such as source code, which may be compiled in order to be executed by a computer's central processing unit or by a controller, or an intermediate form, such as object code, which is produced by a compiler. As used herein, the term “software code” or “code” also includes any human-understandable computer instructions or set of instructions, e.g., a script, that may be executed on the fly with the aid of an interpreter executed by a computer's central processing unit or by a controller.

It will also be understood that the terms and expressions used herein have the ordinary meaning as is accorded to such terms and expressions with respect to their corresponding respective areas of inquiry and study except where specific meanings have otherwise been set forth herein. The terms “comprises,” “comprising,” “includes,” “including,” or any other variation thereof, are intended to cover a non-exclusive inclusion, such that a process, method, article, or apparatus that has, comprises or includes a list of elements or steps does not include only those elements or steps but may include other elements or steps not expressly listed or inherent to such process, method, article, or apparatus. An element preceded by “a” or “an” does not, without further constraints, preclude the existence of additional identical elements in the process, method, article, or apparatus that comprises the element.

While the foregoing has described what are considered to be the best mode and/or other examples, it is understood that various modifications may be made therein and that the subject matter disclosed herein may be implemented in various forms and examples, and that they may be applied in numerous applications, only some of which have been described herein. It is intended by the following claims to claim any and all modifications and variations that fall within the true scope of the present concepts.

What is claimed is:

1. A computer-implemented method for analyzing sounds within a vehicle interior and controlling ambient light system within the vehicle interior, said method comprising the steps of:
(a) connecting a software application to a vehicle network;
(b) capturing, by the software application, at least one sound within the vehicle interior;
(c) analyzing, by the software application, the at least one sound captured within the vehicle interior; and
(d) changing an appearance of at least one portion of the ambient light system within the vehicle interior based on the captured at least one sound within the vehicle interior.

2. The computer-implemented method of claim 1, wherein the at least one portion of the ambient light system within the vehicle interior comprises light emitting diodes (“LEDs”) arranged and configured to provide illumination around a dashboard, a center console, door handles, cupholders, door panels, or footwells of the vehicle.

3. The computer-implemented method of claim 1, wherein the software application includes a memory having a plurality of different saved appearances of the ambient light system within the vehicle interior, each saved appearance corresponding with a unique sound.

4. The computer-implemented method of claim 3, wherein the software application is installed on a mobile device.

5. The computer-implemented method of claim 3, wherein the plurality of different appearances of the ambient light system within the vehicle interior comprises at least one of color, brightness, color sequence, or flash sequence, or at least one of color, brightness, color sequence, or flash sequence of at least one of a plurality of zones within the vehicle.

6. The computer-implemented method of claim 5, wherein the plurality of zones within the vehicle comprise a front right zone, a front left zone, a rear right zone, and a rear left zone.

7. The computer-implemented method of claim 3, wherein each of the plurality of different appearances of the ambient lights within the vehicle interior corresponds to at least one type of music played within the vehicle interior.

8. The computer-implemented method of claim 7, wherein each of the plurality of different appearances of the ambient lights within the vehicle interior corresponds to at least one characteristic of the music played within the vehicle interior.

9. The computer-implemented method of claim 8, wherein the at least one characteristic of the music played within the vehicle interior comprises beats per minute (“BPM”).

10. The computer-implemented method of claim 1, wherein the software application comprises a microphone and the at least one sound within the vehicle interior is captured by the microphone.

11. The computer-implemented method of claim 1, further comprising displaying the software application on a screen of the vehicle.

12. The computer-implemented method of claim 11, further comprising one of enabling or disabling of the software application on the screen of the vehicle.

13. The computer-implemented method of claim 1, wherein the ambient light system within the vehicle interior is operatively connected to or forms part of an infotainment system of the vehicle.

14. The computer-implemented method of claim 13, wherein the software application is loaded on a mobile device and the changing the appearance of the ambient light system within the vehicle interior is performed by an infotainment system of the vehicle based on a control signal from the software application.

15. The computer-implemented method of claim 14, wherein the changing the appearance of the ambient light system within the vehicle interior is performed by the software application via a vehicle network application programming interface (“API”).

16. A computer program product for analyzing sounds within a vehicle interior and controlling ambient light system within the vehicle interior, the computer program product being stored in a non-transitory computer-readable recording medium, wherein the computer program product is configured for:
(a) connecting to a vehicle network;
(b) capturing, by the software application, of at least one sound within the vehicle interior; and
(c) changing an appearance of the ambient light system within the vehicle interior based on the captured at least one sound within the vehicle interior.

17. A vehicle comprising the computer program product of claim 16.

18. A smartphone comprising the computer program product of claim 16.
